(19) United States
(12) Patent Application Publication
(10) Pub. No.: US 2006/0278579 A1
(43) Pub. Date: Dec. 14, 2006

(54) Method for separating semiconducting and metallic carbon nanotubes

(75) Inventors: Jae Young Choi, Gyeonggi-Do (KR); Seon Mi Yoon, Gyeonggi-Do (KR); Young Gyoon Ryu, Gyeonggi-Do (KR); Eun Sun Lee, Seoul (KR); Ki Yong Song, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/396,690

(22) Filed: Apr. 4, 2006

(30) Foreign Application Priority Data
Jun. 8, 2005 (KR) 2005-48766

(51) Int. Cl. B01D 11/04

(52) U.S. Cl. 210/634

(57) ABSTRACT

A method for separating semiconducting and metallic carbon nanotubes by selectively plating metallic carbon nanotubes via electroless plating to precipitate the plated metallic carbon nanotubes and filtering the precipitated metallic carbon nanotubes. According to an example method, metallic and semiconducting carbon nanotubes may be effectively separated from each other in a simple manner and/or at a low cost.

This non-provisional application claims priority under 35 U.S.C. § 119(a) on Korean Patent Application No. 2005-48766 filed on Jun. 8, 2005, which is herein incorporated by reference.

### BACKGROUND OF THE INVENTION

1. Field of the Invention

Example embodiments of the present invention relate to a method for separating semiconducting and metallic carbon nanotubes, and more particularly to a method for separating semiconducting and metallic carbon nanotubes by selectively plating metallic carbon nanotubes via electroless plating to precipitate the plated metallic carbon nanotubes, and filtering the precipitated metallic carbon nanotubes.

2. Description of the Related Art

Numerous studies have been conducted on carbon nanotubes. Carbon nanotubes are rolled-up sheets of graphite and typically have a diameter of 1-20 nm. Graphite has a unique bonding arrangement of carbon atoms and is composed of strong, flat, hexagonal and plate-like layers whose upper and lower portions are filled with free electrons. The electrons move in parallel directions to the layers in a discrete state. Because the graphite layers are wrapped in a helical arrangement to form a carbon nanotube, bonding of edges occurs at different points. It was reported that the electrical properties of carbon nanotubes are a function of the structure and diameter of the carbon nanotubes.

That is, it was proved that the electrical properties, e.g. insulating, semiconducting and metallic properties, of the same material may vary depending on the structure and diameter of the material. Changes in the helical structure or chirality of carbon nanotubes may affect the movement manner of free electrons, thus allowing the free electrons to move completely freely. As a result, carbon nanotubes may exhibit the same reactivity as metals. Otherwise, the carbon nanotubes may have a barrier, like semiconductors. The size of the barrier may be determined by the diameter of the carbon nanotubes. It is known that the barrier amounts to 1 eV even at the smallest diameter of the nanotubes.

As demonstrated above, carbon nanotubes may have excellent mechanical strength and/or chemical stability and may exhibit both semiconducting and conducting properties. In addition, carbon nanotubes may be thin, long and hollow in appearance. Based on these characteristics, carbon nanotubes may have many applications as materials for electronic devices, for example, flat panel displays, transistors and/or energy reservoirs, and may be applicable to a variety of nanometer-scale electronic devices.

Generally, synthetic carbon nanotubes are bulk carbon nanotubes including semiconducting and metallic carbon nanotubes. Only semiconducting carbon nanotubes are needed to apply carbon nanotubes to transistors. In this connection, a known technique for separating semiconducting and metallic. carbon nanotubes may be performed by attaching a chemical reactive substance (e.g., a diazonium reagent) to the surface of single-walled carbon nanotubes. According to this technique, only metallic carbon nanotubes can be selectively converted to semiconducting carbon nanotubes, and thus the single-walled carbon nanotubes are converted to semiconducting carbon nanotubes. However, the chemically reactive substance (e.g., a diazonium reagent) may remain on the surface of the semiconducting carbon nanotubes converted from the metallic carbon nanotubes.

Further, a known separation technique of metallic carbon nanotubes from semiconducting carbon nanotubes may be performed by depositing the metallic carbon nanotubes on a metal. This method, however, has a problem in that only a few of the metallic carbon nanotubes are substantially separated.

Another known separation technique of metallic and semiconducting carbon nanotubes may be performed by adsorbing bromine atoms to the metallic carbon nanotubes using charge transfer of the bromine atoms. However, this method has drawbacks of a long separation time and separation of only a few of the carbon nanotubes.

### SUMMARY OF THE INVENTION

Example embodiments of the present invention provide a method for separating and/or extracting semiconducting and metallic carbon nanotubes from each other.

Example embodiments of the present invention provide a method for separating and/or extracting large numbers of semiconducting and metallic carbon nanotubes from each other in a simple manner.

Example embodiments of the present invention provide a method for separating and/or extracting large numbers of semiconducting and metallic carbon nanotubes from each other by electroless plating.

Example embodiments of the present invention provide a method for separating and/or extracting large numbers of semiconducting and metallic carbon nanotubes from each other at a lower cost.

Example embodiments of the present invention provide a method for separating and/or extracting large numbers of semiconducting and metallic carbon nanotubes from each other in order to manufacture Tera-level semiconductors.

In accordance with an example embodiment of the present invention, there is provided a method for separating semiconducting and metallic carbon nanotubes, comprising adding bulk carbon nanotubes including metallic and semiconducting carbon nanotubes to an electroless plating solution, selectively plating the metallic carbon nanotubes to precipitate the metallic carbon nanotubes, and separating the precipitated metallic carbon nanotubes from the electroless plating solution.

### BRIEF DESCRIPTION OF THE DRAWINGS

The above and other objects, features and/or advantages of example embodiments of the present invention will be more clearly understood from the following detailed description taken in conjunction with the accompanying drawings, in which:

FIG. 1 is a flow chart schematically illustrating a method for separating semiconducting and metallic carbon nanotubes according to an example embodiment of the present invention;

FIG. 2 is a scanning electron micrograph (SEM) of metallic carbon nanotubes precipitated after plating in accordance with an example embodiment of the present invention;

FIG. 3 is an energy dispersive spectrum (EDS) of metallic carbon nanotubes precipitated after plating in accordance with an example embodiment of the present invention;

FIG. 4 shows Raman spectra of bulk carbon nanotubes of Comparative Example 1 and semiconducting carbon nanotubes separated in Examples 1, 3 and 4 of the present invention at 514 nm; and

FIG. 5 shows Raman spectra of bulk carbon nanotubes of Comparative Example 1 and metallic carbon nanotubes separated in Examples 1-4 of the present invention at 633 nm.

### DESCRIPTION OF EXAMPLE EMBODIMENTS OF THE PRESENT INVENTION

The present invention is described more fully hereinafter with reference to the accompanying drawings, in which example embodiments of the present invention are shown. The present invention may, however, be embodied in many different forms and should not be construed as limited to the embodiments set forth herein. Rather, these example embodiments are provided so that this disclosure will be thorough and complete, and will fully convey the scope of the present invention to those skilled in the art. In the drawings, the sizes and/or relative sizes of layers and/or regions may be exaggerated for clarity.

It will be understood that. when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

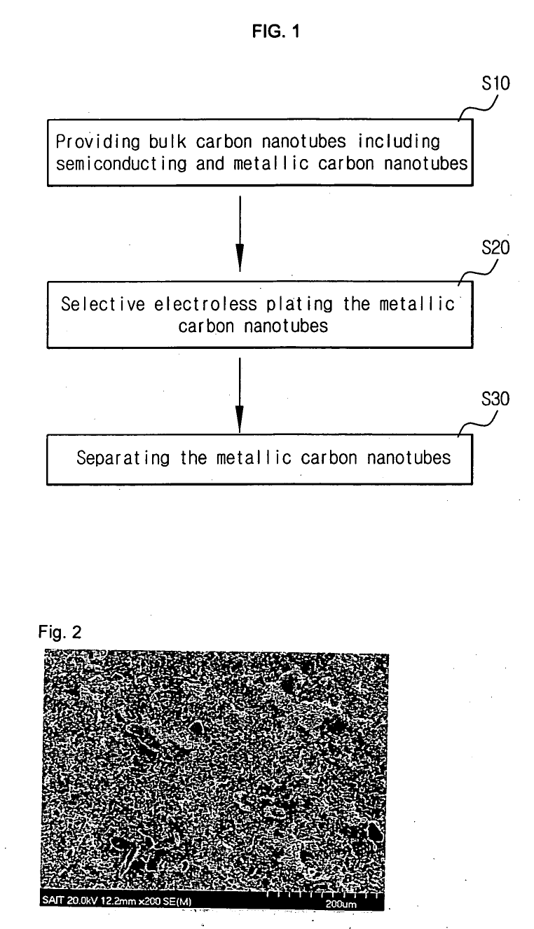

FIG. 1 is a flow chart schematically illustrating a method for separating semiconducting and metallic carbon nanotubes. Separation of semiconducting and metallic carbon nanotubes from bulk carbon nanotubes may be required for effective application of the semiconducting carbon nanotubes to devices. In example embodiments of the present invention, separation of semiconducting and metallic carbon nanotubes is achieved by electroless plating.

As shown in FIG. 1 an example embodiment of the present invention may include providing bulk carbon nanotubes including semiconducting and metallic carbon nanotubes at S10, selectively electroless plating the metallic carbon nanotubes at S20, and/or separating the metallic carbon nanotubes at S30.

Generally when nickel (Ni) is plated on the surface of a material, a nickel salt is added to water and the nickel salt is ionized in water to form the nickel ions Ni²⁺. The nickel ions are reduced to nickel metal in the presence of a reducing agent or by an externally applied voltage [Ni²⁺+2e →Ni], completing the nickel plating.

Such plating may be classified into electroplating and electroless plating. In electroplating, electrons (the left side of the above reaction) are supplied from an electrode. Accordingly, electroplating is useful when it is intended to plate a metal on a metallic plate or object, which can act as an electrode. However, electroplating cannot be employed in the plating of a metal on the surface of particles, for example, a powder. This is because a powder to be plated cannot be attached to an electrode.

In contrast, electroless plating may be employed in the plating of a metal on particles. Electroless plating may be divided into displacement plating and reduction plating. Displacement plating is based on the following principle. For example, when a copper salt is added to an iron powder, the iron provides electrons to copper ions and is dissolved because iron has a greater ionization tendency than copper. The copper ions are reduced and are attached to the iron powder. That is, a first material to be plated receives electrons provided from a powder of a second material whose ionization tendency is greater than the first material, completing plating the first material on the surface of the powder of the second material.

Reduction plating utilizes the principle that electrons necessary for plating are supplied from a reducing agent. In this case, reduction plating is achieved by simultaneously adding a reducing agent and a nickel salt to an aqueous solution. The reducing agent functions as a metal powder whose ionization tendency is relatively high in displacement plating and functions as an anode plate in electroplating.

In summary, electrons are supplied from an anode in electroplating, from a material to be plated in displacement plating, and from a reducing agent in reduction plating.

Selective plating may occur in electroless plating, and its principle is mainly applied to the production of high-density substrates, for example, substrates for cell phones. For example, electroless nickel is plated to a thickness of about 5 microns on copper, and gold is plated to a thickness of 0.03 microns on the nickel by electroless plating. That is, nickel is not plated over the surface of a substrate, but is selectively plated on metal copper by electroless plating. Accordingly, electroless plating is useful in the manufacture of high-density circuit boards.

Example embodiments of the present invention may utilize the principle that nickel is selectively plated on the surface of a metal by electroless plating. Specifically, according to example embodiments of the present invention, only the surface of metallic carbon nanotubes in bulk carbon nanotubes including metallic and semiconducting carbon nanotubes is selectively plated and coated. The coating may be carried out in the form of a film. The surface-coated metallic carbon nanotubes may be precipitated due to their increased weight. The semiconducting carbon nanotubes may remain dissolved in a plating solution, unlike the precipitated metallic carbon nanotubes. The precipitated metallic carbon nanotubes may be separated from the plating solution to leave the semiconducting carbon nanotubes behind. In this manner, the metallic carbon nanotubes may be effectively separated from the semiconducting carbon nanotubes in a simple manner.

For example, for bulk carbon nanotubes, there can be used, without particular limitation, any commercially available carbon nanotubes which are produced by common techniques, including arc discharge, laser ablation, high-temperature filament plasma chemical vapor deposition, microwave plasma chemical vapor deposition, thermal chemical vapor deposition, pyrolysis, etc. The bulk carbon nanotubes are likely to aggregate in view of their inherent characteristics, however, a dispersant may be used to prevent collision and aggregation of the bulk carbon nanotubes and to sufficiently disperse the bulk carbon nanotubes. Specific examples of suitable dispersants include cationic, anionic and non-ionic surfactants, and high molecular weight polymeric dispersants, for example, polyvinyl alcohol. Such surfactants and polymeric dispersants may be those commercially provided to or purchased by those skilled in the art, for example, sodium dodecylbenzene sulfonate (C₁₂H₂₅C₆H₄SO₃Na, NaDDBS), sodium dodecyl sulfate (C₁₂H₂₅OSO₃Na, SDS), Triton X-100 (C₈H₁₇C₆H₄(OCH₂CH₂)₁₀OH), dodecyltrimethylammonium bromide (CH₃(CH₂)₁₁N(CH₃)₃Br, DTAB), gum arabic (GA), starch, and polyvinyl pyrrolidone (PVP).

The electroless plating solution used in example embodiments of the present invention is not specially limited, and any commercially available product can be used. For example, a nickel, gold, or other plating solution may be used as the electroless plating solution. In an example embodiment, a low-priced nickel plating solution may be used. In an example embodiment, nickel is provided in a suitable salt form. Examples of suitable nickel salts include nickel sulfate hexahydrate, nickel chloride hexahydrate, nickel sulfaminate, nickel methanesulfonic acid, nickel acetate, nickel carbonate, nickel hydroxide, and mixtures thereof.

In addition to the nickel salt, the electroless plating solution may contain a reducing agent for providing electrons to metal ions to reduce the metal ions to the corresponding metal, a pH-adjusting agent for controlling the plating rate, reduction efficiency, etc., a complexing agent for reducing or preventing precipitation of a metal salt during pH adjustment, and/or an additive for controlling the plating efficiency of a metal.

For example, sodium hypophosphite, sodium borohydride, hydrazine or the like may be used as the reducing agent, caustic soda, ammonium hydroxide, an inorganic acid, an organic acid or the like may be used as the pH-adjusting agent, ammonia, sodium citrate, sodium acetate, ethylene glycol or the like may be used as the complexing agent, and Pd or the like may be used as the additive. However, these materials do not serve to limit example embodiments of the present invention.

Plating using the electroless plating solution may be conducted by dipping the bulk carbon nanotubes in the plating solution at 40-100° C. for 1-60 minutes, for example, at 50-80° C. for 2-40 minutes, or for example, at 60-70° C. for 5-30 minutes.

After completion of the plating, an additional separation processes, for example, natural precipitation, centrifugation, magnetization or filtration, may be employed to enhance the separation efficiency of the metallic carbon nanotubes.

The present invention will now be described in more detail with reference to the following examples. However, the examples are given for the purpose of illustration and are not to be construed as limiting the scope of the invention.

### EXAMPLES 1-4

2 mg of bulk carbon nanotubes was added to 200 mg of sodium dodecylbenzene sulfonate (C₁₂H₂₅C₆H₄SO₃Na, NaDDBS) as a dispersant. The mixture was subjected to sonication for 24 hours to obtain a dispersion. The dispersion was centrifuged at 20,000 rpm for 30 minutes to remove precipitated carbon nanotubes (CNTs) and to prepare a carbon nanotube dispersion. The carbon nanotube dispersion was added to a nickel plating solution containing 10 g/L Ni(CH₃COO)₂.H₂O, 20 g/L NH₄CH₃COO and 20 g/L NaH₂PO₂.H₂O, and metallic nanotubes were selectively plated under different conditions indicated in Table 1 below to precipitate the plated metallic carbon nanotubes. Subsequently, the precipitated metallic carbon nanotubes were separated from the solution by centrifugation (5,600 rpm, 10 min.), leaving semiconducting carbon nanotubes behind.

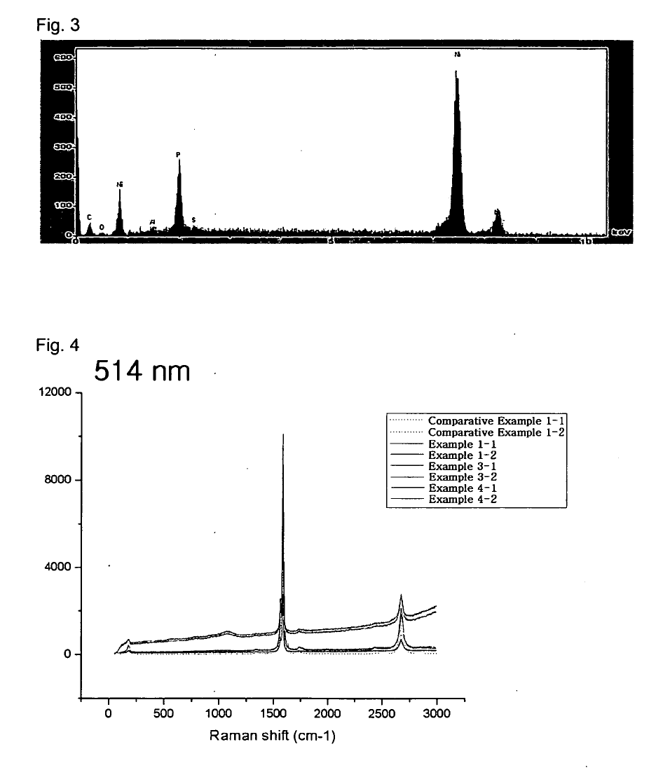

FIGS. 2 and 3 are a scanning electron microscope (SEM, S4700, manufactured by Hitachi) image and an energy dispersive spectroscopy (EDS, manufactured by Noran) spectrum of the metallic carbon nanotubes precipitated in Example 4, respectively. The spectrum shown in FIG. 3 demonstrates that the palladium (Pd) added as an additive was not detected and the phosphorus (P) originating from the reducing agent was present.

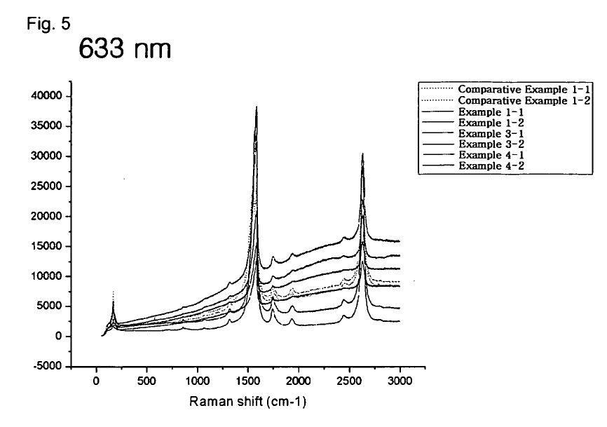

The bulk sample including the semiconducting and metallic carbon nanotubes (Comparative Example 1) and the semiconducting carbon nanotubes were analyzed twice by Raman spectroscopy (System3000, manufactured by Renishaw) at 514 nm. The analytical results are shown in FIG. 4. The separated metallic carbon nanotubes were analyzed twice by Raman spectroscopy at 633 nm, and the obtained analytical results are shown in FIG. 5. The Raman spectroscopy data of the bulk sample (Comparative Example 1) and the separated carbon nanotubes (Example 1) are shown in Table 2 below.

TABLE 1

| | Example 1 | Example 2 | Example 3 | Example 4 |
|---|---|---|---|---|
| Pd solution (drops) | 0 | 0 | 2 | 2 |
| Ni plating solution (ml) | 5 | 5 | 5 | 5 |
| Carbon nanotube solution | 5 | 5 | 5 | 5 |
| (ml) | | | | |
| Time (min.) | 10 | 30 | 10 | 30 |
| Temp.(° C.) | 80 | 80 | 80 | 80 |

TABLE 2

| | 514 | | | 633 | | | 514/633 |
|---|---|---|---|---|---|---|---|
| | (Semiconducting) | | | (Metallic) | | | (Semiconducting/ |
| | G | RBM | RBM/G | G | RBM | RBM/G | metallic) |
| Comparative | 5273 | 205 | 0.039 | 27749 | 7510 | 0.271 | 0.144 |
| Example 1 | | | | | | | |
| Example 1 | 8664 | 382 | 0.044 | 38354 | 6007 | 0.157 | 0.282 |
| Example 2 | 2753 | 171 | 0.062 | 15809 | 2420 | 0.153 | 0.406 |
| Example 4 | 7271 | 706 | 0.097 | 34081 | 5094 | 0.149 | 0.650 |

As can be seen from the data shown in Table 2, considering the ratios between the peak sizes of the semiconducting carbon nanotubes at 514 nm and those of the metallic carbon nanotubes at 633 nm, as measured by Raman spectroscopy, the ratio of the bulk carbon nanotubes is 0.144, while the ratios between the semiconducting carbon nanotubes and the metallic carbon nanotubes separated by nickel electroless plating in Examples 1, 2 and 4 are 0.282, 0.406 and 0.650, respectively. These results indicate that the number of semiconducting carbon nanotubes has increased when compared to those of the metallic carbon nanotubes. Therefore, the carbon nanotubes were effectively separated in Examples 1, 2 and 4, compared to in Comparative Example 1.

As apparent from the above description, according to example embodiments of the present invention, metallic and semiconducting carbon nanotubes, for example, large numbers of metallic and semiconducting carbon nanotubes may be effectively separated from each other in a simple manner (e.g., by electroless plating) in a short time.

Although example embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for separating semiconducting and metallic carbon nanotubes, comprising:
adding bulk carbon nanotubes including metallic and semiconducting carbon nanotubes to an electroless plating solution;
selectively plating the metallic carbon nanotubes to precipitate the metallic carbon nanotubes; and
separating the precipitated metallic carbon nanotubes from the electroless plating solution.

2. The method according to claim 1, wherein the bulk carbon nanotubes are dispersed in a dispersant selected from the group consisting of cationic, anionic, non-ionic, and polymeric surfactants.

3. The method according to claim 2, wherein the bulk carbon nanotubes are dispersed in a dispersant selected from the group consisting of sodium dodecylbenzene sulfonate (C₁₂H₂₅C₆H₄SO₃Na, NaDDBS), sodium dodecyl sulfate (C₁₂H₂₅OSO₃Na, SDS), Triton X-100 (C₈H₁₇C₆H₄(OCH₂CH₂)₁₀OH), dodecyltrimethylammonium bromide (CH₃(CH₂)₁₁N(CH₃)₃Br, DTAB), gum arabic (GA), starch, and polyvinyl pyrrolidone (PVP).

4. The method according to claim 1, wherein the electroless plating solution is a nickel or gold plating solution.

5. The method according to claim 4, wherein the nickel solution includes a nickel salt.

6. The method according to claim 5, wherein the nickel salt includes nickel sulfate hexahydrate, nickel chloride hexahydrate, nickel sulfaminate, nickel methanesulfonic acid, nickel acetate, nickel carbonate, nickel hydroxide, and mixtures thereof.

7. The method according to claim 1, wherein the electroless plating solution includes at least one of a reducing agent, a pH-adjusting agent, a complexing agent, and an additive for controlling the plating efficiency of the nickel.

8. The method according to claim 7, wherein the reducing agent is selected from the group consisting of sodium hypophosphite, sodium borohydride, and hydrazine, the complexing agent is selected from the group consisting of ammonia, sodium citrate, sodium acetate, and ethylene glycol, the pH-adjusting agent is selected from the group consisting of caustic soda, ammonium hydroxide, an inorganic acid, and an organic acid, and the additive is palladium (Pd).

9. The method according to claim 1, wherein the electroless plating solution contains palladium (Pd).

10. The method according to claim 1, wherein the selectively plating is conducted at 40-100° C. for 1-60 minutes.

11. The method according to claim 10, wherein the selectively plating is conducted at 50-80° C. for 2-40 minutes.

12. The method according to claim 11, wherein the selectively plating is conducted at 60-70° C. for 5-30 minutes.

13. The method according to claim 1, wherein the separating is conducted by a process selected from the group consisting of natural precipitation, centrifugation, magnetization, and filtration.
